(19) United States
(12) Patent Application Publication
(10) Pub. No.: US 2011/0100767 A1
(43) Pub. Date: May 5, 2011

(54) Four-piston hydraulic brake for bikes

(76) Inventor: Fong-Chou Wan, Tainan (TW)

(21) Appl. No.: 12/589,841

(22) Filed: Oct. 30, 2009

(51) Int. Cl. F16D 55/10

(52) U.S. Cl. 188/72.1

(57) ABSTRACT

A four-piston hydraulic brake for bikes comprises a hydraulic cylinder and a brake pad device. Each side of the hydraulic cylinder is set two pistons respectively. An opening is set on one side of the hydraulic cylinder which a space, piston ring grooves 1 and 2 are set thereof. The brake pad device which comprises two brake pads, a spring component and a latch is installed in the space of the hydraulic cylinder. A brake component which several grooves are set thereof is set on one corresponding side of each two brake pad. The spring component is installed between two brake pads. The latch assembles the brake pads and the spring component.

### BACKGROUND OF THE PRESENT INVENTION

1. Field of the invention

The present invention relates to a four-piston hydraulic brake for bikes, that each side of the hydraulic cylinder is set two pistons respectively, and the brake pad device comprises a pair of corresponding brake pads, a spring component and a latch.

2. Description of the prior art

Please refer to the Taiwanese Utility Model application which its publication number is 150632 and the title is “The Improved Structure of Wire-Transmitted Hydraulic Brake” (prior invention). The prior invention comprises a pump and a disc brake, and the disc brake is a one-piston structure. Two brake pads which a brake ring is set on each corresponding side are set in the hydraulic cylinder.

However, the prior invention mentioned foregoing has some disadvantages as following:

1. The prior invention relates to a one-piston structure, thus it may lack the power to brake a vehicle.
2. There isn't any assistant unit to return the brake pads to their original position, thus the speed of returning the position of the brake pads and the piston may be slow.
3. There is no grooves on the brake ring of the brake pad, thus the dirt in the disc brake could not be discharged. Furthermore, the brake pads might be deformed because of the heat or the coldness.

### SUMMARY OF THE INVENTION

Referring to FIGS. 1 through 6, the present invention relates to a four-piston hydraulic brake for bikes comprising a hydraulic cylinder and a brake pad device, wherein each side of the hydraulic cylinder is set two pistons respectively. An opening is set on one side, and a space, piston ring grooves 1 and 2 are set inside. The brake pad device which comprises two corresponding brake pads, a spring component and a latch is installed in the space of the hydraulic cylinder. A brake component which several grooves are set thereof is set on one corresponding side of each two brake pad respectively. The spring component is installed between two brake pads. The latch assembles the brake pads and the spring component.

### BRIEF DESCRIPTION OF THE DRAWINGS

FIG. 1 is a perspective view of the present invention.

FIG. 2 is a schematic drawing illustrating the hydraulic cylinder and the brake pad device of the present invention.

FIG. 3 is a schematic drawing illustrating the brake pad of the present invention.

FIG. 4 is a perspective rear view of the present invention.

FIG. 5 is a perspective top view of the present invention.

FIG. 6 is a perspective view of the present invention installed in the disc.

### DETAILED DESCRIPTION OF THE INVENTION

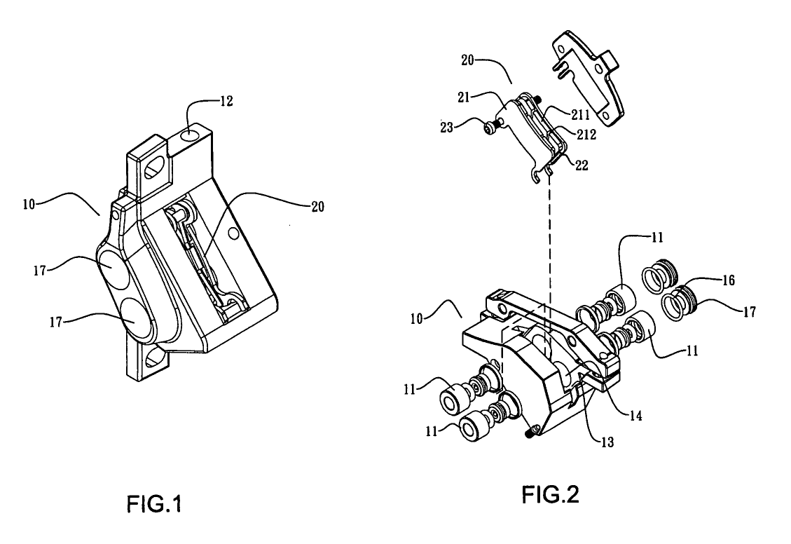

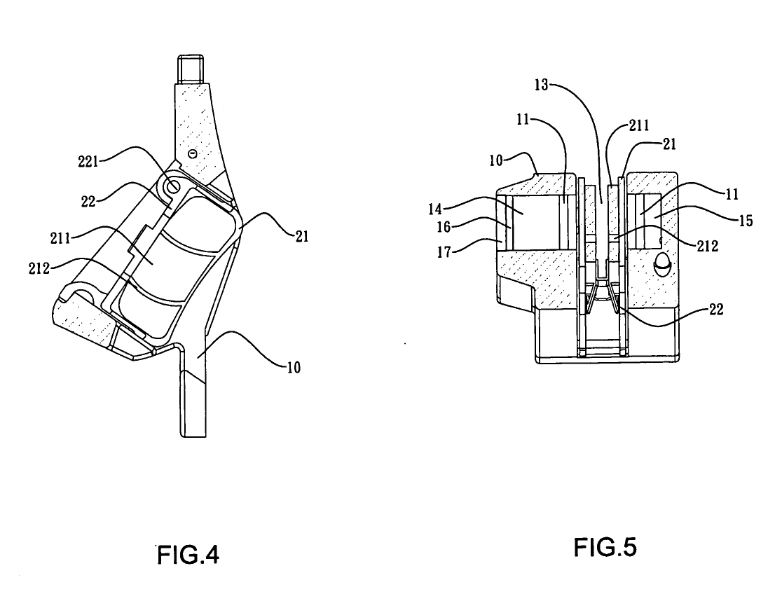

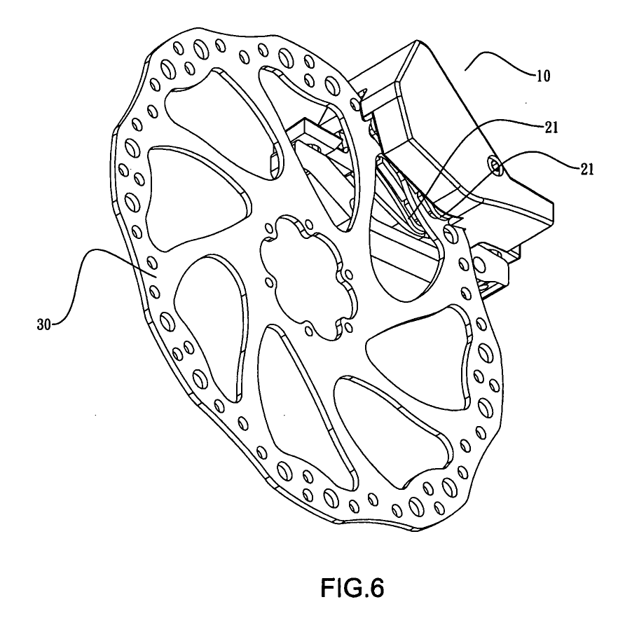

Referring to FIGS. 1 through 6, a four-piston hydraulic brake for bikes comprises a hydraulic cylinder (10) and a brake pad device (20). Each side of the hydraulic cylinder (10) is set two pistons (11) respectively, and an opening (12) is set on one side. Piston ring groove 1 (14) and piston ring groove 2 (15) on each inner side of the space (13) in the hydraulic cylinder (10) are to contain the two pistons (11) thereof. Piston ring groove 1 (14) penetrates through the hydraulic cylinder (10) from the space (13), yet piston ring groove 2 (15) just has the length for containing the piston (11).

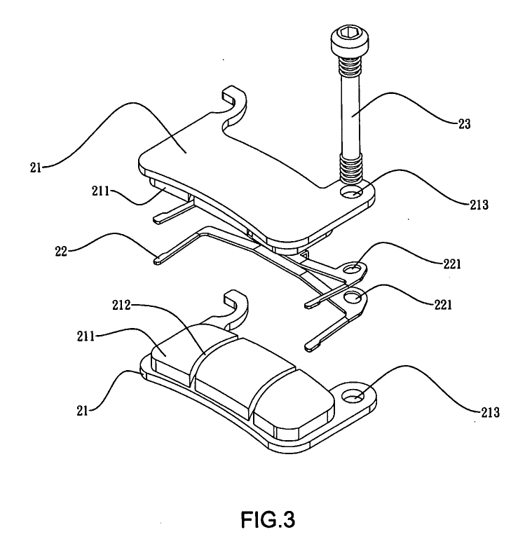

Please refer to FIG. 3, the brake pad device (20) which comprises two corresponding brake pads (21), a spring component (22) and a latch (23) is installed in the space (13) of the hydraulic cylinder (10). A hole (213) is set on the surface of the brake pad (21), and a brake component (211) with several grooves (212) is set on the corresponding side of each two brake pad (21). The spring component (22) with corresponding holes (221) is installed between two brake pads (21). The latch (23) assembles the brake pads (21) and the spring component (22) through the holes (213) on brake pads (21) and the holes (221) on spring component (22).

Please refer to FIGS. 3 and 5, the first pair of pistons (11) is installed in piston ring groove 2 (15) through the space (13), and then set the brake pad device (20) in the space (13), finally install the second pair pistons (11) in piston ring groove 1 (14) and seal piston ring groove 1 (14) with an O-ring (16) and a screw cap (17).

When press the hydraulic brake through the opening (12) of the hydraulic cylinder (10), the four pistons (11) of the front and rear sides press the brake pad device (20) inwardly. At the meantime, the two brake pads (21) lean each other tightly to enable the brake component (211) lean against the disc (30). When the vehicle stops and the hydraulic pressure recedes, the spring component (22) between the two brake pads (21) pushes out the two brake pads (21) along with the pistons (11) rapidly. Thus the brake pads (21) and the pistons (11) may return to their position after braking.

The present invention mentioned foregoing has the advantages as following:

1. Each front side and rear side of the hydraulic cylinder (10) is set two pistons (11), thus the four pistons (11) increase the power for the brake pads (21) to press from both sides. Besides, it may improve the friction coefficient at the same time.
2. The brake component (211) of the brake pads (21) is set several grooves (212) thereon, therefore it may prevent the deformation because of the heat or the coldness, and discharge the dirt through the grooves (212).
3. The spring component (22) between the two brake pads (21) of the present invention may speed the brake pads (21) and the pistons (11) back to their position after stopping the vehicle, thus it will increase the braking power.

I claim:

1. A four-piston hydraulic brake for bikes comprising:
a hydraulic cylinder which each side of said hydraulic cylinder is set two pistons respectively, wherein an opening is set on one side, a space is set in the middle inside of said hydraulic cylinder, piston ring groove 1 and piston ring groove 2 are set on each inner side of said space;
a brake pad device comprising two corresponding brake pads, a spring component and a latch is installed in said space of said hydraulic cylinder.

2. A four-piston hydraulic brake for bikes as recited in claim 1, wherein said piston ring groove 1 penetrates through said hydraulic cylinder, yet piston ring groove 2 just has the length for containing said piston.

3. A four-piston hydraulic brake for bikes as recited in claim 1, wherein a brake component with several grooves is set on the corresponding side of each said two brake pad, a hole is set on the surface of each said brake pad respectively.

4. A four-piston hydraulic brake for bikes as recited in claim 1, wherein said spring component with corresponding holes is installed between said two brake pads.

5. A four-piston hydraulic brake for bikes as recited in claim 1, wherein said latch assembles said brake pads and said spring component through said holes on said brake pads and said holes on said spring component.
